(19) United States
(12) Patent Application Publication
(10) Pub. No.: US 2023/0034609 A1
(43) Pub. Date: Feb. 2, 2023

(54) DETECTION METHOD FOR ROGUE ACCESS POINTS, ELECTRONIC DEVICE AND COMPUTER READABLE STORAGE MEDIUM

(71) Applicant: Nanning FuLian FuGui Precision Industrial Co., Ltd., Nanning (CN)

(72) Inventor: Cheng-Yi HUANG, New Taipei (TW)

(21) Appl. No.: 17/386,930

(22) Filed: Jul. 28, 2021

(51) Int. Cl. H04W 12/122; H04W 12/61; H04B 17/318; H04W 48/20

(52) U.S. Cl. CPC H04W 12/122; H04W 12/61; H04B 17/318; H04W 48/20

(57) ABSTRACT

A detection method for rogue access points is disclosed. Timestamps of beacon packets of each access point (AP) in multiple wireless AP are collected. Clock skews of each of the APs are calculated based on the collected timestamps. Clock skew models of each of the APs are established according to the clock skews of each of the APs. It is determined whether a rogue AP is detected. A plurality of legal APs adjacent to the rogue AP are selected if the rogue AP is detected. Received signal strength indicator (RSSI) values relative to the rogue AP are collected via the selected legal APs. The rogue AP is localized according to the collected RSSI values.

### BACKGROUND

### 1. Technical Field

The disclosure relates to detection methods, and more particularly to a detection method for rogue access points, electronic device and readable storage medium.

### 2. Description of Related Art

A rogue Wi-Fi Access Point (AP) is a Wi-Fi AP set up by malicious attackers without legal authorization of an enterprise network management unit. The malicious attackers steal important business secrets of a company via connections to illegal Wi-Fi APs, causing the company to suffer huge business losses. Therefore, the enterprise network must have the ability to detect and suppress illegal Wi-Fi APs to ensure the security of the enterprise network.

Currently, an enterprise-level network equipment mainly uses active Scanning and passive Scanning to detect illegal Wi-Fi Aps, but cannot detect illegal Wi-Fi APs that counterfeit media access control (MAC) addresses of authorized Wi-Fi APs, and there is no related methods to locate positions of the illegal Wi-Fi APs.

### BRIEF DESCRIPTION OF THE DRAWINGS

Many aspects of the present disclosure can be better understood with reference to the following figures. The components in the figures are not necessarily drawn to scale, the emphasis instead being placed upon clearly illustrating the principles of the present disclosure. Moreover, in the drawings, like reference numerals designate corresponding parts throughout the several views. Implementations of the present technology will now be described, by way of embodiments, with reference to the attached figures, wherein:

FIG. 1 is a flowchart of an embodiment of a detection method for rogue access points (APs) of the present disclosure;

FIG. 2 is a schematic diagram of an embodiment of clock skew creation of the present disclosure;

FIG. 3 is a flowchart of an embodiment of localizing rogue APs of the present disclosure;

FIG. 4 is a schematic diagram of an embodiment of received signal strength indicator (RSSI) vector values of the present disclosure;

FIG. 5 is a schematic diagram of an embodiment of detecting rogue APs of the present disclosure;

FIG. 6 is a schematic diagram of an embodiment of localizing rogue APs of the present disclosure;

FIG. 7 is a schematic diagram of an embodiment of calculating a distance between monitor points and rogue APs of the present disclosure;

FIG. 8 is a schematic diagram of an embodiment of a state machine of an authorized AP of the present disclosure;

FIG. 9 is a block diagram of an embodiment of the hardware architecture of an electronic device using the method of the present disclosure;

FIG. 10 is a block diagram of an embodiment of functional blocks of the electronic device using the method of the present disclosure; and

FIG. 11 is a block diagram of an embodiment of functional blocks of a localizing module of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “comprising,” when utilized, means “including, but not necessarily limited to”; it specifically indicates open-ended inclusion or membership in the so-described combination, group, series, and the like.

The timestamp field of a beacon packet of a wireless base station, i.e., a Wi-Fi access point (AP), records the time when the beacon packet was transmitted. The time is directly written in in the beacon packet by a radio frequency (RF) chip of the Wi-Fi AP and is irrelevant to the delay of a media access control (MAC) layer of the Wi-Fi AP. The clock of the Wi-Fi AP is generated by an oscillator and a counter.

Devices with the same hardware components may also have different clock skews. The clock skew is generated by inconsistent oscillation frequency of a quartz oscillator of an electronic clock, which is increased with the increase of the device's power-on time.

In an embodiment of a detection method for rogue access points of the present invention, a wireless intrusion detector receives all beacon packets on all wireless transmission channels, and records timestamps in the beacon packets of each of the APs to establish clock skew models of each of the APs. By continuously updating the clock skew models of each of the APs, if an abnormal clock skew model is discovered, it can be determined that the AP corresponding to the abnormal clock skew model is an illegal AP.

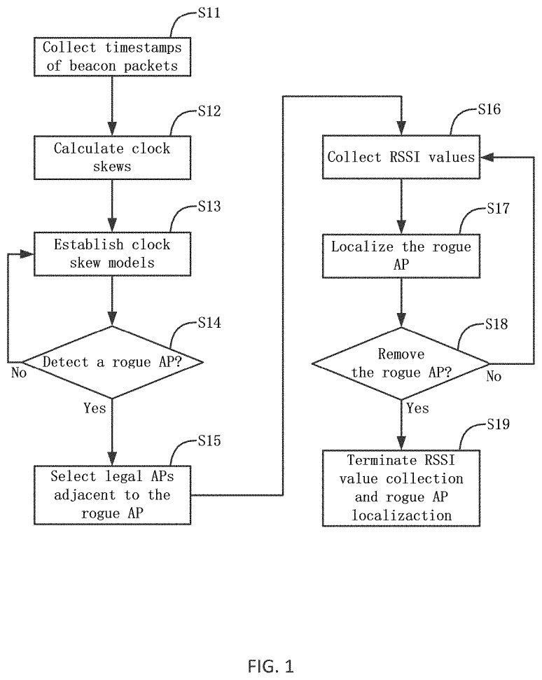

FIG. 1 is a flowchart of an embodiment of a detection method for rogue access points of the present disclosure. According to different needs, the order of the steps in the flowchart can be changed, and some steps can be omitted.

In step S11, timestamps of beacon packets of each access point (AP) in multiple wireless AP are collected.

A wireless intrusion detector scans wireless transmission channels of each of the APs, records the timestamps in the beacon packets of each of the APs, for example, T₀, T₁, T₂, . . . , and calculates time difference values of each of the beacon packets based on the timestamps as a database used for establishing the clock skew models of each of the APs.

In step S12, clock skews of each of the APs are calculated based on the collected timestamps.

In step S13, clock skew models of each of the APs are established according to the clock skews of each of the APs.

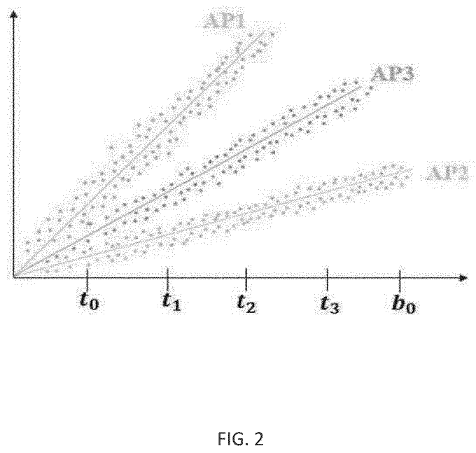

Suppose a clock skew mode of an AP is Ŷᵢ=b₀+b₁Xᵢ, where b₀ is the initial value of the clock skew and b₁ is an increasing slope of the clock skew. As b₀ and b₁ is estimated through a least square method, the clock skew model of each AP can be obtained, as shown in FIG. 2.

In step S14, it is determined whether a rogue AP is detected. If the rogue AP is not detected, the process proceeds to step S13 for continuously establishing the clock skew models of each of the APs.

In step S15, a plurality of legal APs adjacent to the rogue AP are selected if the rogue AP is detected, for example, at least 3 legal AP are selected.

In step S16, received signal strength indicator (RSSI) values relative to the rogue AP are collected via the selected legal APs.

In step S17, the rogue AP is localized according to the collected RSSI values.

In step S18, it is determined whether the rogue AP has been removed. If the rogue AP has not been removed, the process proceeds to step S16 for continuously enabling the selected legal APs to collect RSSI values relative to the rogue AP.

In step S19, operations of collecting the RSSI values and localizing the rogue AP are terminated if the rogue AP has been removed.

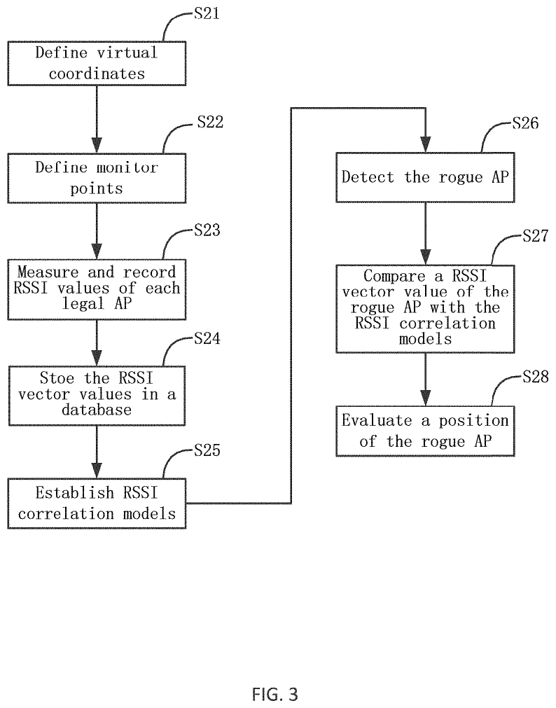

FIG. 3 is a flowchart of an embodiment of localizing rogue APs of the present disclosure. According to different needs, the order of the steps in the flowchart can be changed, and some steps can be omitted.

In step S21, virtual coordinates of the legal APs in a network service area are defined.

A service area of a corporate wireless network is configured into a plane space with virtual coordinates. Virtual coordinates, {X₁, X₂, X₃, . . . , Xₙ}, are configured for each of the legal APs to use the legal APs to detect a relative position of the rogue AP and predict coordinates of the rogue AP.

In step S22, at least one monitor point is defined in the network service area.

One or more monitor points {P₁, P₂, P₃, . . . , Pₙ} in the plane space of the virtual coordinates are selected as one or more reference points for measuring the RSSI values of each of the legal APs.

In step S23, RSSI values of each of the legal APs are measured and recorded to obtain RSSI vector values of the monitor point relative to legal APs.

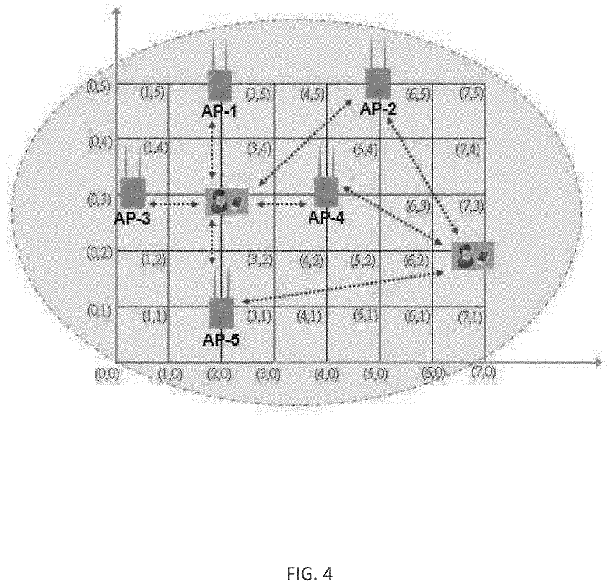

When the wireless network is installed, the signal strength of each of the legal APs is measured and recorded through one or more terminal devices at the monitor points to establish RSSI vectors of the legal APs related to each of the virtual coordinates. In addition, the signal strength of the legal APs is measured at each of the monitor points to establish RSSI correlation vectors of each of the legal APs related to the monitor points, for example, M1 and M2, as shown in FIG. 4. Table 1 records the RSSI correlation vectors of each of the legal APs related to the monitor points.

TABLE 1

| | Monitor Points | | | |
|---|---|---|---|---|
| Legal AP | P₁(a₁, b₁) | P₂(a₂, b₂) | . . . | Pₙ(aₙ, bₙ) |
| AP₁(x₁, y₁) | −35 | −45 | . . . | −55 |
| AP₂(x₂, y₂) | −45 | −55 | . . . | −35 |
| . | . | . | . . . | . |
| . | . | . | | . |
| . | . | . | | . |
| APₘ(xₘ, yₘ) | −55 | −45 | . . . | −65 |

In step S24, the RSSI vector values are stored in a database.

In step S25, multiple RSSI correlation models of the legal APs related to the monitor point are established based on the RSSI vector values.

In step S26, the rogue AP is detected according to the RSSI correlation models.

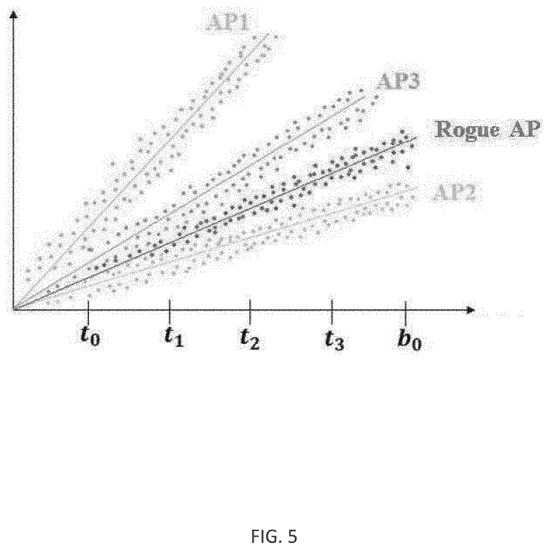

The wireless intrusion detection device continuously scans all wireless channels and collects beacon packet information of the APs. As the clock skew models of each of the APs are established, the increase slope, b₁, of the clock skew of each of the APs are compared. If there is an unknown b₁, it can be determined that the AP having the unknown b₁ is an rogue AP, as shown in FIG. 5.

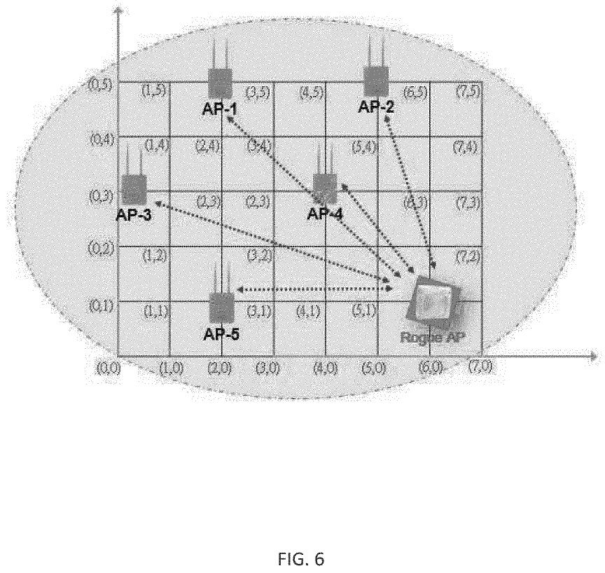

When the rogue AP is detected, a wireless network controller notifies each of the legal APs to report the RSSI vector value of the detected rogue AP, so that the wireless network controller can locate the coordinates of the rogue AP, as shown in Table 2 and FIG. 6.

TABLE 2

| | Monitor Points | | | | |
|---|---|---|---|---|---|
| Legal AP | P₁(a₁, b₁) | P₂(a₂, b₂) | . . . | Pₙ(aₙ, bₙ) | Pᵣ(aₙ₊₁, bₙ₊₁) |
| AP₁(x₁, y₁) | −35 | −45 | . . . | −55 | −65 |
| AP₂(x₂, y₂) | −45 | −55 | . . . | −35 | −55 |
| . | . | . | . . . | . | . |
| . | . | . | | . | . |
| . | . | . | | . | . |
| APₘ(xₘ, yₘ) | −55 | −45 | . . . | −65 | −45 |

The wireless network controller receives the RSSI vector values of the rogue AP detected by each of the legal APs, reconstructs the RSSI vectors of the legal APs, and send the RSSI vectors to the clock skew model of the rogue AP to calculate the coordinates of the rogue AP.

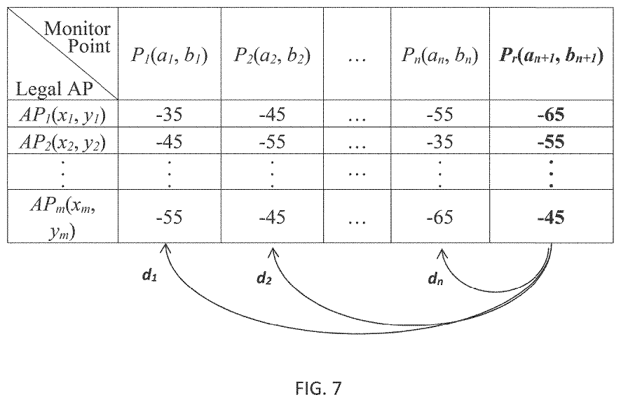

The clock skew model of the rogue AP obtains a monitor point closest to the rogue AP and predicts the coordinates of the rogue AP by calculating the “Cosine Distance”, ‘d’, between the rogue AP and each of the monitor points, as shown in FIG. 7.

In step S27, the RSSI vector value of the rogue AP is compared with the RSSI correlation models.

In step S28, a position of the rogue AP is evaluated according to the comparing result.

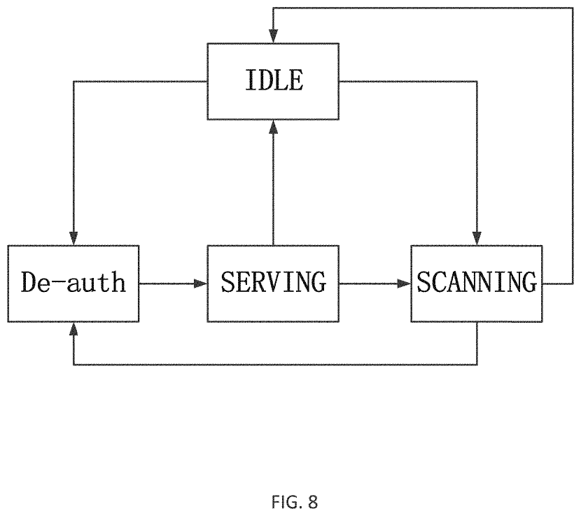

FIG. 8 is a schematic diagram of an embodiment of a state machine of an authorized AP of the present disclosure.

The legal AP works in a normal state of serving wireless clients (SERVING) when an event notification of the rogue AP is not received. When an event notification that a rogue AP is detected in the company's wireless network environment is received, the legal AP enters the state of scanning the rogue APs (SCANNING). If an event notification that a legitimate client connects to a rogue AP is received, the legal AP enters the De-auth state (De-auth), which interrupts the connection between the legitimate wireless clients and the rogue AP in the way of sending De-auth packets.

When the event notification of a rogue AP is received, the legal AP enters the scanning state (SCANNING) from the idle state (IDLE), which means to detect the rogue AP, obtains RSSI values of the neighboring APs, and detect whether there is a rogue AP.

When an event notification that a legitimate client connects to the rogue AP is received, the legal AP enters the illegal connection state (De-auth) from the idle state (IDLE) and interrupts the connection between the legitimate wireless clients and the rogue AP in the way of sending De-auth packets.

When the legal AP enters the idle state (IDLE) from the scanning state (SCANNING), which means to terminate the operation of detecting rogue APs, scanning the RSSI value of neighboring APs is stopped, and a report is sent to a wireless network management system (WNMS).

When the legal AP enter the illegal connection state (De-auth) from the scanning state (SCANNING), which means that an event notification that a legitimate client connects to the rogue AP is received, the legal AP enters the illegal connection state (De-auth) from the idle state (IDLE), and interrupts the connection between the legitimate wireless clients and the rogue AP in the way of sending De-auth packets.

As the legal AP has disconnected the connection between the legal wireless client and the rogue AP, it is switch to the normal operation state when it enters the service state (SERVING) from the illegal connection state (De-auth).

When the legal AP enters the idle state (IDLE) from the service state (SERVING), no operation is performed.

When the legal AP enters the scanning state (SCANNING) from the service state (SERVING), which means to detect the rogue AP, it obtains the RSSI values of the neighboring APs and detects whether there is a rogue AP.

An embodiment of the detection method for rogue APs detects whether there are rogue APs in the enterprise wireless network in real time. In addition, the clock skew detection used in the embodiment can prevent illegal APs from counterfeiting the MACs of legal APs in the enterprise wireless network. Further, the embodiment of the detection method can not only improve the accuracy of the positioning model through self-learning based on data obtained by monitor points, but also quickly locate the rogue APs, which greatly improving security of the enterprise wireless network.

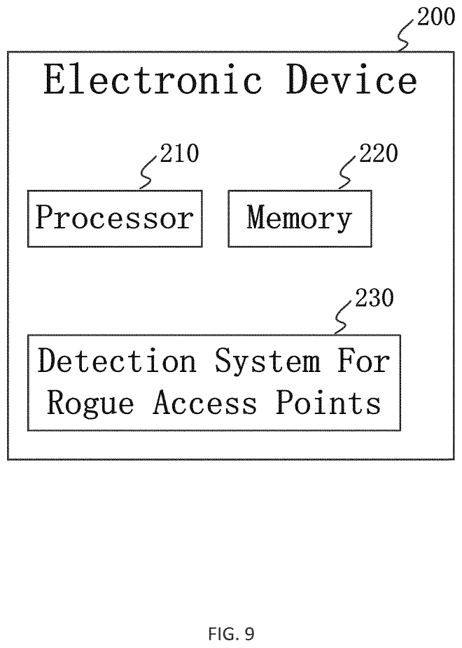

FIG. 9 is a block diagram of an embodiment of the hardware architecture of an electronic device using the detection method for rogue access points of the present disclosure. The electronic device 200 may, but is not limited to, connect to a processor 210, a memory 220, and a detection system for rogue access points 230 via system buses. The electronic device 200 shown in FIG. 9 may include more or fewer components than those illustrated, or may combine certain components.

The memory 220 stores a computer program, such as the detection system for rogue access points 230, which is executable by the processor 210. When the processor 210 executes the detection system for rogue access points 230, the blocks in one embodiment of the booting mode configuration method applied in the electronic device 200 are implemented, such as blocks S11 to S19 shown in FIG. 1 and blocks S21 to S28 shown in FIG. 3.

It will be understood by those skilled in the art that FIG. 9 is merely an example of the electronic device 200 and does not constitute a limitation to the electronic device 200. The electronic device 200 may include more or fewer components than those illustrated, or may combine certain components. The electronic device 200 may also include input and output devices, network access devices, buses, and the like.

The processor 210 may be a central processing unit (CPU), or other general-purpose processors, a digital signal processor (DSP), an application specific integrated circuit (ASIC), a Field-Programmable Gate Array (FPGA), or another programmable logic device, discrete gate or transistor logic device, discrete hardware components, or the like. The processor 210 may be a microprocessor or other processor known in the art.

The memory 220 can be used to store the detection system for rogue access points 230 and/or modules/units by running or executing computer programs and/or modules/units stored in the memory 220. The memory 220 may include a storage program area and a storage data area. In addition, the memory 220 may include a high-speed random access memory, a non-volatile memory such as a hard disk, a plug-in hard disk, a smart memory card (SMC), and a secure digital (SD) card, flash card, at least one disk storage device, flash device, or other volatile solid state storage device.

The detection system for rogue access points 230 can be partitioned into one or more modules/units that are stored in the memory 220 and executed by the processor 210. The one or more modules/units may be a series of computer program instructions capable of performing particular functions of the detection system for rogue access points 230.

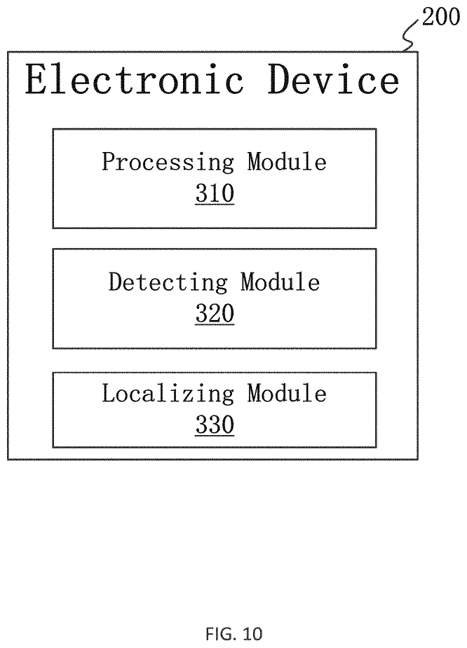

FIG. 10 is a schematic diagram of an embodiment of functional blocks of the electronic device using the method of the present disclosure. The electronic device 200 comprises a processing module 310, a detecting module 320 and a localizing module 330.

The processing module 310 is configured to collect timestamps of beacon packets of each access point (AP) in multiple wireless AP.

A wireless intrusion detector scans wireless transmission channels of each of the APs, records the timestamps in the beacon packets of each of the APs, for example, T₀, T₁, T₂, . . . , and calculates time difference values of each of the beacon packets based on the timestamps as a database used for establishing the clock skew models of each of the APs.

The processing module 310 calculates clock skews of each of the APs based on the collected timestamps and establishes clock skew models of each of the APs according to the clock skews of each of the APs.

Suppose a clock skew mode of an AP is Ŷᵢ=b₀+b₁Xᵢ, where b₀ is the initial value of the clock skew and b₁ is an increasing slope of the clock skew. As b₀ and b₁ is estimated through a least square method, the clock skew model of each AP can be obtained, as shown in FIG. 2.

The detecting module 320 is configured to determine whether a rogue AP is detected. If the rogue AP is not detected, the process proceeds to continuously establish the clock skew models of each of the APs.

The detecting module 320 selects a plurality of legal APs adjacent to the rogue AP if the rogue AP is detected, for example, at least 3 legal AP are selected, and collects received signal strength indicator (RSSI) values relative to the rogue AP via the selected legal APs.

The localizing module 330 is configured to localize the rogue AP according to the collected RSSI values and determine whether the rogue AP has been removed. If the rogue AP has not been removed, the detecting module 320 continuously selects the RSSI values relative to the rogue AP via the selected legal APs. If the rogue AP has been removed, the detecting module 320 and the localizing module 330 terminate the operations of collecting the RSSI values and localizing the rogue AP.

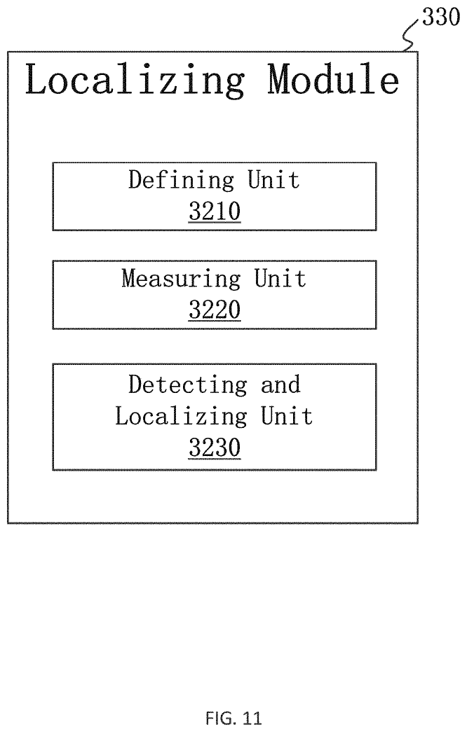

FIG. 11 is a block diagram of an embodiment of functional blocks of a localizing module of the present disclosure. The localizing module 330 comprises a defining unit 3310, a measuring unit 3320 and a detecting and localizing unit 3330.

The defining unit 3310 defines virtual coordinates of the legal APs in a network service area.

A service area of a corporate wireless network is configured into a plane space with virtual coordinates. Virtual coordinates, {X₁, X₂, X₃, . . . , Xₙ}, are configured for each of the legal APs to use the legal APs to detect a relative position of the rogue AP and predict coordinates of the rogue AP.

The defining unit 3310 defines at least one monitor point in the network service area.

One or more monitor points {P₁, P₂, P₃, . . . , Pₙ} in the plane space of the virtual coordinates are selected as one or more reference points for measuring the RSSI values of each of the legal APs.

The measuring unit 3320 measures and records RSSI values of each of the legal APs to obtain RSSI vector values of the monitor point relative to legal APs.

When the wireless network is installed, the signal strength of each of the legal APs is measured and recorded through one or more terminal devices at the monitor points to establish RSSI vectors of the legal APs related to each of the virtual coordinates. In addition, the signal strength of the legal APs is measured at each of the monitor points to establish RSSI correlation vectors of each of the legal APs related to the monitor points, for example, M1 and M2, as shown in FIG. 4. Table 1 records the RSSI correlation vectors of each of the legal APs related to the monitor points.

TABLE 1

| | Monitor Points | | | |
|---|---|---|---|---|
| Legal AP | P₁(a₁, b₁) | P₂(a₂, b₂) | . . . | Pₙ(aₙ, bₙ) |
| AP₁(x₁, y₁) | −35 | −45 | . . . | −55 |
| AP₂(x₂, y₂) | −45 | −55 | . . . | −35 |
| . | . | . | . . . | . |
| . | . | . | | . |
| . | . | . | | . |
| APₘ(xₘ, yₘ) | −55 | −45 | . . . | −65 |

The measuring unit 3320 stores the RSSI vector values in a database.

The measuring unit 3320 establishes multiple RSSI correlation models of the legal APs related to the monitor point based on the RSSI vector values.

The detecting and localizing unit 3330 detects the rogue AP according to the RSSI correlation models.

The wireless intrusion detection device continuously scans all wireless channels and collects beacon packet information of the APs. As the clock skew models of each of the APs are established, the increase slope, b₁, of the clock skew of each of the APs are compared. If there is an unknown b₁, it can be determined that the AP having the unknown b₁ is an rogue AP, as shown in FIG. 5.

When the rogue AP is detected, a wireless network controller notifies each of the legal APs to report the RSSI vector value of the detected rogue AP, so that the wireless network controller can locate the coordinates of the rogue AP, as shown in Table 2 and FIG. 6.

TABLE 2

| | Monitor Points | | | | |
|---|---|---|---|---|---|
| Legal AP | P₁(a₁, b₁) | P₂(a₂, b₂) | . . . | Pₙ(aₙ, bₙ) | Pᵣ(aₙ₊₁, bₙ₊₁) |
| AP₁(x₁, y₁) | −35 | −45 | . . . | −55 | −65 |
| AP₂(x₂, y₂) | −45 | −55 | . . . | −35 | −55 |
| . | . | . | . . . | . | . |
| . | . | . | | . | . |
| . | . | . | | . | . |
| APₘ(xₘ, yₘ) | −55 | −45 | . . . | −65 | −45 |

The wireless network controller receives the RSSI vector values of the rogue AP detected by each of the legal APs, reconstructs the RSSI vectors of the legal APs, and send the RSSI vectors to the clock skew model of the rogue AP to calculate the coordinates of the rogue AP.

The clock skew model of the rogue AP obtains a monitor point closest to the rogue AP and predicts the coordinates of the rogue AP by calculating the “Cosine Distance”, ‘d’, between the rogue AP and each of the monitor points, as shown in FIG. 7.

The detecting and localizing unit 3330 compares the RSSI vector value of the rogue AP with the RSSI correlation models.

The detecting and localizing unit 3330 evaluates a position of the rogue AP according to the comparing result.

It is to be understood, however, that even though numerous characteristics and advantages of the present disclosure have been set forth in the foregoing description, together with details of the structure and function of the present disclosure, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A detection method for rogue access points executable by an electronic device, comprising:
collecting timestamps of beacon packets of each access point (AP) in multiple wireless AP;
calculating clock skews of each of the APs based on the collected timestamps;
establishing clock skew models of each of the APs according to the clock skews of each of the APs;
determining whether a rogue AP is detected;
selecting a plurality of legal APs adjacent to the rogue AP if the rogue AP is detected;
collecting, via the selected legal APs, received signal strength indicator (RSSI) values relative to the rogue AP; and
localizing the rogue AP according to the collected RSSI values.

2. The method of claim 1, the step of localizing the rogue AP according to the collected RSSI values further comprises:
defining virtual coordinates of the legal APs in a network service area;
defining at least one monitor point in the network service area;
measuring and recording RSSI values of each of the legal APs to obtain RSSI vector values of the monitor point relative to legal APs;
storing the RSSI vector values in a database;
establishing multiple RSSI correlation models of the legal APs related to the monitor point based on the RSSI vector values;
detecting the rogue AP according to the RSSI correlation models;
comparing a RSSI vector value of the rogue AP with the RSSI correlation models; and
evaluating a position of the rogue AP according to the comparing result.

3. The method of claim 2, further comprising:
selecting the monitor point in a plane space of the virtual coordinate as a reference point for measuring the RSSI values of each of the legal APs.

4. The method of claim 1, further comprising:
determining whether the rogue AP has been removed; and
terminating operations of collecting the RSSI values and localizing the rogue AP if the rogue AP has been removed.

5. The method of claim 4, further comprising:
continuously collecting, via the selected legal APs, RSSI values relative to the rogue AP if the rogue AP has not been removed.

6. The method of claim 1, the step of collecting the timestamps of the beacon packets of each of the AP in the multiple wireless AP further comprises:
scanning, via a wireless intrusion detector, wireless transmission channels of each of the APs;
recording the timestamps in the beacon packets of each of the APs; and
calculating time difference values of each of the beacon packets based on the timestamps as a database used for establishing the clock skew models of each of the APs.

7. An electronic device, comprising:
a processing module, configured to collect timestamps of beacon packets of each access point (AP) in multiple wireless AP, calculate clock skews of each of the APs based on the collected timestamps, and establish clock skew models of each of the APs according to the clock skews of each of the APs;
a detecting module, configured to determine whether a rogue AP is detected, select a plurality of legal APs adjacent to the rogue AP if the rogue AP is detected, and collect, via the selected legal APs, received signal strength indicator (RSSI) values relative to the rogue AP; and
a localizing module, configured to localize the rogue AP according to the collected RSSI values.

8. The device of claim 7, wherein the localizing module further comprises:
a defining unit, configured to define virtual coordinates of the legal APs in a network service area and define at least one monitor point in the network service area;
a measuring unit, configured to measure and record RSSI values of each of the legal APs to obtain RSSI vector values of the monitor point relative to legal APs, and store the RSSI vector values in a database; and
a detecting and localizing unit, configured to establish multiple RSSI correlation models of the legal APs related to the monitor point based on the RSSI vector values, detect the rogue AP according to the RSSI correlation models, compare a RSSI vector value of the rogue AP with the RSSI correlation models, and evaluate a position of the rogue AP according to the comparing result.

9. The device of claim 7, wherein the detecting and localizing unit determines whether the rogue AP has been removed, and, if the rogue AP has been removed, terminates operations of collecting the RSSI values and localizing the rogue AP.

10. A non-transitory computer-readable storage medium, storing computer program which causes a computer to execute:
a process of collecting timestamps of beacon packets of each access point (AP) in multiple wireless AP;
a process of calculating clock skews of each of the APs based on the collected timestamps;
a process of establishing clock skew models of each of the APs according to the clock skews of each of the APs;
a process of determining whether a rogue AP is detected;
a process of selecting a plurality of legal APs adjacent to the rogue AP if the rogue AP is detected;
a process of collecting, via the selected legal APs, received signal strength indicator (RSSI) values relative to the rogue AP; and
a process of localizing the rogue AP according to the collected RSSI values.
